(19) United States
(12) Patent Application Publication
(10) Pub. No.: US 2026/0017113 A1
(43) Pub. Date: Jan. 15, 2026

(54) RECOMMENDATION PRIORITIZATION FOR A CONTAINER ORCHESTRATION SYSTEM

(71) Applicant: Kyndryl, Inc., New York, NY (US)

(72) Inventors: Glincy Mary Jacob, Chengannur (IN); Arun Kumar Thondapu, Bangalore (IN); Jethin Paul, Bangalore (IN)

(21) Appl. No.: 18/772,384

(22) Filed: Jul. 15, 2024

(51) Int. Cl. G06F 9/50; G06F 9/455; G06F 11/07

(52) U.S. Cl. CPC G06F 9/5061; G06F 9/45558; G06F 11/0751; G06F 11/0793; G06F 2009/4557

(57) ABSTRACT

Computer-implemented methods for recommendation prioritization for a container orchestration system. Aspects include receiving a set of recommendations for a cluster of a container orchestration system. Aspects also include selecting an optimal recommendation from the set of recommendations using a scored knowledge transform graph. Aspects further include generating a confidence score for the cluster based on the optimal recommendation. Aspects also include determining a category of a readiness assessment model for the cluster using the confidence score. Aspects further include modifying a computer resource of the cluster based on the category of the readiness assessment model.

### BACKGROUND

The present invention generally relates to computer systems, and more specifically, to computer-implemented methods, computer systems, and computer program products configured and arranged to prioritize recommendations for a cluster in a container orchestration system.

A container orchestration system is a system for automating software deployment, scaling, and management of containerized applications. An open-source example of a container orchestration system is the Kubernetes platform. A Kubernetes cluster of the Kubernetes platform includes one or more worker machines, also called nodes, which run containerized applications. The nodes host the Kubernetes pods, also referred to as pods, which are the smallest deployable units of computing that can be created and managed in the Kubernetes platform. Pods are a group of one or more containers with shared storage and network resources and a specification for how to run the containers. A control plane of the Kubernetes platform manages the worker nodes and the pods in the cluster. Each pod includes a Kubelet, which is a node-level agent that communicates with the control plane and manages pod deployment, resource management, and health monitoring of the clusters.

### SUMMARY

Embodiments of the present invention are directed to computer-implemented methods for recommendation prioritization system for a container orchestration system. A non-limiting computer-implemented method includes receiving a set of recommendations for a cluster of a container orchestration system. The method also includes selecting an optimal recommendation from the set of recommendations using a scored knowledge transform graph. The method further includes generating a confidence score for the cluster based on the optimal recommendation. The method also includes determining a category of a readiness assessment model for the cluster using the confidence score. The method further includes modifying a computer resource of the cluster based on the category of the readiness assessment model.

In one embodiment of the present invention, the method includes receiving data including logs, events, and details of a pod of the container orchestration system in the cluster. The method also includes identifying an error from the data. The method further includes determining a remediation action for the error. The method also includes generating a recommendation for the set of recommendations. The recommendation for the set of recommendations includes the error, the remediation action, an error category for the error, and a risk level for the error.

In one embodiment of the present invention, generating the confidence score for the cluster based on the optimal recommendation further includes using a history of recommendations for the cluster, a discrepancy score of the optimal recommendation, and a monitoring score indicative of monitoring availability in the cluster.

In one embodiment of the present invention, selecting the optimal recommendation from the set of recommendations using the scored knowledge transform graph further includes generating a discrepancy score for each recommendation of the set of recommendations. The method also includes selecting the optimal recommendation from the set of recommendations using the discrepancy score for each recommendation of the set of recommendations. In some embodiments, the discrepancy score for each recommendation of the set of recommendations is generated using a ratio of added resources and a ratio of released resources of the cluster based on each recommendation of the set of recommendations.

In one embodiment of the present invention, the readiness assessment model includes four categories and each of the four categories corresponds to a respective level of an ability of the cluster to implement the optimal recommendation.

In one embodiment of the present invention, the method includes generating an impact report of the optimal recommendation on the cluster comprising the optimal recommendation, the confidence score of the cluster, and the category of the readiness assessment model for the cluster.

According to another non-limiting embodiment of the invention, a system having a memory having computer readable instructions and one or more processors for executing the computer readable instructions, the computer readable instructions controlling the one or more processors to perform operations. The operations include receiving a set of recommendations for a cluster of a container orchestration system. The operations also include selecting an optimal recommendation from the set of recommendations using a scored knowledge transform graph. The operations further include generating a confidence score for the cluster based on the optimal recommendation. The operations also include determining a category of a readiness assessment model for the cluster using the confidence score. The operations further include modifying a computer resource of the cluster based on the category of the readiness assessment model.

According to another non-limiting embodiment of the invention, a computer program product is provided. The computer program product includes a computer-readable storage medium having program instructions embodied therewith, the program instructions executable by a processor to cause the processor to perform operations. The operations include receiving a set of recommendations for a cluster of a container orchestration system. The operations also include selecting an optimal recommendation from the set of recommendations using a scored knowledge transform graph. The operations further include generating a confidence score for the cluster based on the optimal recommendation. The operations also include determining a category of a readiness assessment model for the cluster using the confidence score. The operations further include modifying a computer resource of the cluster based on the category of the readiness assessment model.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 depicts a block diagram of an example system for recommendation prioritization for a container orchestration system in a computing environment in accordance with one or more embodiments of the present invention;

FIG. 3 is a data flow diagram for recommendation prioritization for a container orchestration system in a computing environment in accordance with one or more embodiments of the present invention;

FIG. 4 is a block diagram of example scored knowledge transformation graphs for recommendation prioritization for a container orchestration system in accordance with one or more embodiments of the present invention;

FIG. 5 is a flowchart of a computer-implemented method for generating a recommendation in a container orchestration system in a computing environment in accordance with one or more embodiments of the present invention;

FIG. 6 is a flowchart of a computer-implemented method for assessing the readiness of container clusters in a container orchestration system in a computing environment in accordance with one or more embodiments of the present invention;

FIG. 7 depicts a cloud computing environment in accordance with one or more embodiments of the present invention; and

FIG. 8 depicts abstraction model layers in accordance with one or more embodiments of the present invention.

### DETAILED DESCRIPTION

Disclosed herein are methods, systems, and computer program products for recommendation prioritization for a container orchestration system. A container orchestration system is used for automating software deployment, scaling, and management of containerized applications. Containers allow applications to be easily and rapidly deployed and broken down into smaller pieces for more granular management. Container clusters are built to be available, patched and updated, scaled to meet demand, easily instrumented, and easily monitored. Current systems that provide recommendations on how to optimize containers in a cluster can provide recommendation prioritization. However, the recommendation prioritization provided by the systems are usually manual, time consuming, and require subject matter experts. Additionally, the impact of the change in cluster resources associated with different recommendations are not curated. For example, an overutilized container may not need an increased number of resources because resources can be adjusted at the cluster level by releasing the underutilized containers of the cluster. Current systems do not have a means to quantify the confidence with which production clusters can be updated, which can lead to decreased efficiency of deliverables and application upgrades in a container orchestration system.

The systems and methods described herein prioritize recommendations for a container orchestration system using scored knowledge transform graphs and quantify the production readiness of a cluster of the container orchestration system using a readiness assessment model.

In some embodiments, the system can identify errors based on collected data from the container orchestration system. The system receives data associated with a cluster of the container orchestration system, such as the logs, the events, and the pod details. The data is preprocessed and analyzed by a preprocessor to identify errors. The system then uses generative AI engines to identify causes and issues associated with the identified errors and generate remediation actions corresponding to the error. The errors are assigned to an error category and a risk level. The system generates a recommendation that includes the error, remediation action, error category, and risk level.

The system and methods described herein receive a set of recommendations and use scored knowledge transform graphs to generate discrepancy scores for each recommendation of the set of recommendations. An optimal recommendation is selected from the set of recommendations. The optimal recommendation is a recommendation that can be implemented by the container orchestration system with minimal discrepancies to the cluster. A confidence score is generated using the discrepancy score of the optimal recommendation, a monitoring score, and a history of recommendations implemented by the container orchestration system. The confidence score is used to determine a level of production readiness of a cluster of a container orchestration system using a readiness assessment model.

The systems and methods described herein are directed to a recommendation prioritization system that helps user with effective capacity planning, performance monitoring, and resource optimization to reduce cloud spend. The system proactively detects issues, provides accurate root cause analysis, and provides automation and policy-driven management which provides users with enhanced stability and reliability in their container orchestration system. Periodic readiness assessment and benchmarking provide continuous system improvements to adapt to changing needs of the user.

Although the systems and methods described herein are characterized in the context of a Kubernetes platform, the inventive steps can be applied to many different scenarios for recommendation prioritization for container orchestration systems to increase their stability and reliability.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

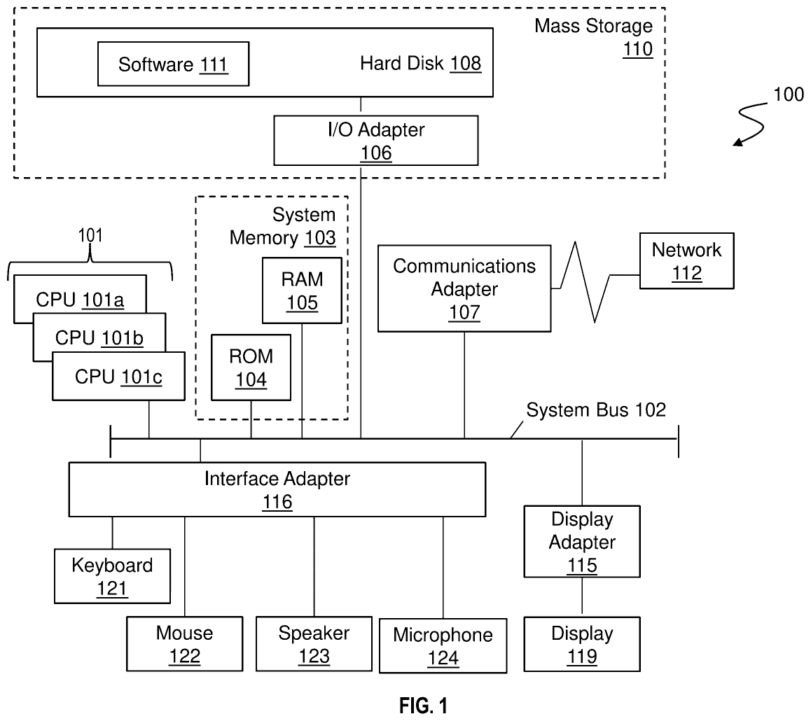

Turning now to FIG. 1, a computer system 100 is generally shown in accordance with one or more embodiments of the invention. The computer system 100 can be an electronic computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, a desktop computer, a laptop computer, a tablet computer, or a smartphone. In some examples, the computer system 100 may be a cloud computing node. The computer system 100 may be described in the general context of computer system executable instructions, such as program modules, being executed by a computer system. Generally, program modules may include routines, programs, objects, components, logic, data structures, and so on that perform tasks or implement abstract data types. The computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc., (collectively or generically referred to as processor(s) 101). The processors 101 can be a single-core processor, a multi-core processor, a computing cluster, or any number of other configurations. The processors 101, also referred to as processing circuits, are coupled via a system bus 102 to a system memory 103 and various other components. The system memory 103 can include a read only memory (ROM) 104 and a random-access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

The software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction is discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, a microphone 124, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computer system 100 includes processing capability in the form of the processors 101, storage capability including the system memory 103 and the mass storage 110, input means such as the keyboard 121, the mouse 122, and the microphone 124, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

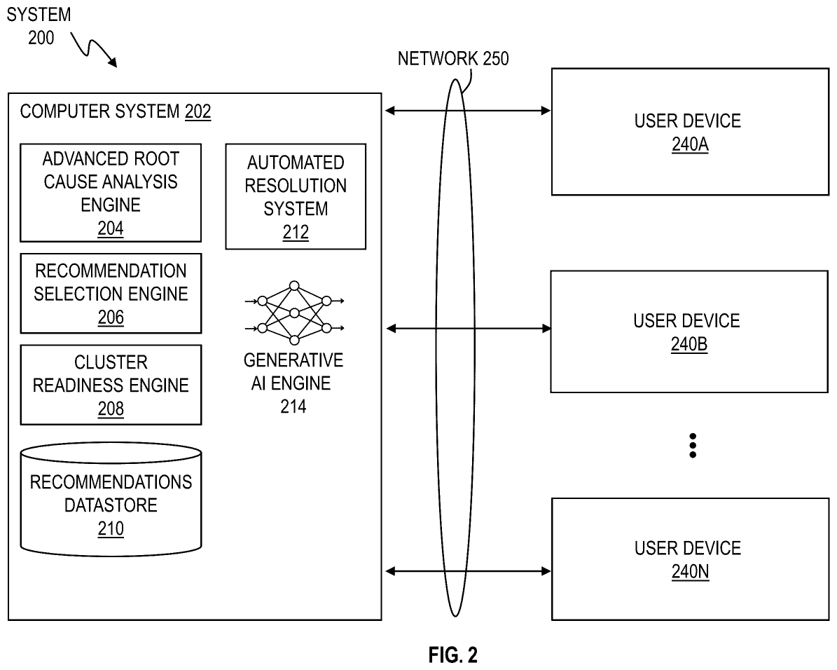

FIG. 2 depicts a block diagram of an example system 200 for recommendation prioritization for a container orchestration system in a computing environment according to one or more embodiments. The system 200 includes a computer system 202 configured to communicate over a network 250 with many different user devices, such as a user device 240A, a user device 240B, through a user device 240N. The user devices 240A, 240B, through 240N can generally be referred to as user device 240 and are utilized to access the computing environment. The user device 240 can be a personal computer or laptop. The user device 240 can be a mobile device such as a cellular phone or tablet, or a smart device. A smart device is an electronic device, generally connected to other devices or networks via different wireless protocols that can operate to some extent interactively. Several notable types of smart devices are smartphones, smart speakers, tablets, smartwatches, smart bands, smart glasses, and many others.

The network 250 can be a wired and/or wireless communication network, and the communication network includes a telecommunications network, the public switched telephone network (PTSN), voice over IP (VOIP) network, etc. The communication network includes cellular networks, satellite networks, etc.

The user devices 240 can include various software and hardware components including software applications (apps) for communicating with one another over the network 250 as understood by one of ordinary skill in the art. The computer system 202, user device(s) 240, an advanced root cause analysis engine 204, a recommendation selection engine 206, a cluster readiness engine 208, and a recommendations datastore 210, etc., can include functionality and features of the computer system 100 in FIG. 1, including various hardware components and various software applications, such as the software 111, which can be executed as instructions on one or more processors 101 in order to perform actions according to one or more embodiments of the invention. The advanced root cause analysis engine 204, recommendation selection engine 206, cluster readiness engine 208, recommendations datastore 210, automated resolution system 212, and a generative artificial intelligence (AI) engine 214 can include, be integrated with, and/or call other pieces of software, algorithms, application programming interfaces (APIs), etc., to operate as discussed herein.

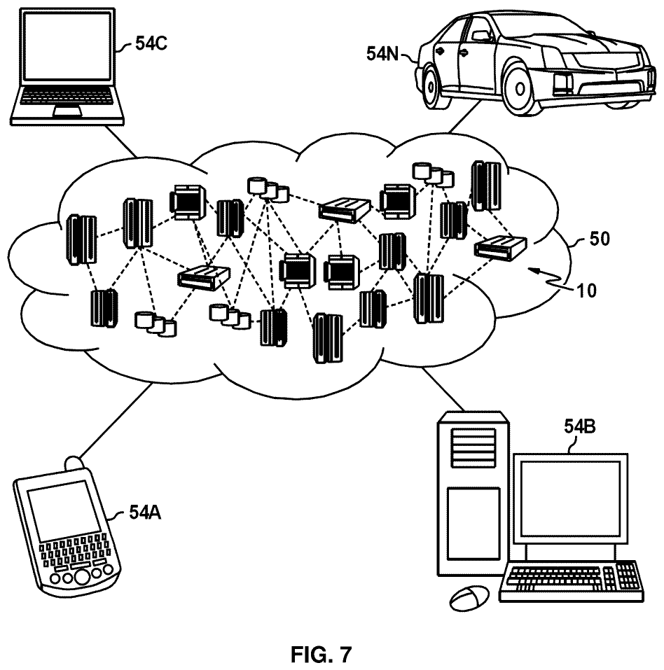

The computer system 202 may be representative of numerous computer systems and/or distributed computer systems configured to utilize a container orchestration system and provide access to the container orchestration system to one or more user devices 240. The computer system 202 can be part of a cloud computing environment such as a cloud computing environment 50 depicted in FIG. 7, as discussed further herein.

In some embodiments, the computer system 202 can include one or more components to prioritize recommendations for a cluster of a container orchestration system, such as the Kubernetes platform, based on its impact on the system in a computing environment. For example, the computer system 202 can include an advanced root cause analysis engine 204, a recommendation selection engine 206, a cluster readiness engine 208, a recommendations datastore 210, an automated resolution system 212, and a generative artificial intelligence (AI) engine 214.

In some embodiments, the advanced root cause analysis engine 204 of the computer system 202 receives data associated with a cluster of a container orchestration system, such as a Kubernetes cluster. The advanced root cause analysis engine 204 can receive data associated with a cluster of the container orchestration system, identify errors or potential errors from the received data, and generate a recommendation to remediate the error. Data includes, but is not limited to, pod details, events, and logs associated with a pod of the container orchestration system. Pod details can include data indicating the status of the pod. Pod details can include the state of each container in the pod.

In some embodiments, the container orchestration system can include events, such as Kubernetes events, which are objects that are used to monitor applications and cluster state, respond to failures, and perform diagnostics. Events are generated when there is a state change in one or more resources of the cluster, such as pods, deployments, or nodes. Events do not typically persist for more than a short period of time. Examples of causes that trigger generation of events include state changes, configuration changes, and scheduling issues. State changes can include the creation of a pod, and changes in pod status to pending, successful, or failed. Configuration changes that can trigger generation of events can include scaling horizontally by adding replicas or scaling vertically by upgrading memory, disk input/output capacity, and/or processor cores. Failed scheduling can generate events. Failures in scheduling can include, but are not limited to, failures due to insufficient resources, invalid container image repository access, or a container fails a liveness or readiness probe.

For example, in the Kubernetes platform there are different types of events. Failed events typically refer to issues creating a container, such as being unable to pull the container image from the repository. Eviction events occur when a node determines that the Kubernetes pods need to be evicted or terminated to free up resources, such as CPU, memory, or disk space. Failed scheduling events occur when the scheduler is unable to find a sufficient node for the Kubernetes pod. FailedMount and FailedAttach Volume are common events caused by a networking or configuration error between the persistent volume and persistent volume claims, which prevents disks from being used by the pods. A persistent volume is a piece of storage in the Kubernetes cluster. A persistent volume claim is a request for storage. A FailedAttach Volume event can occur when a volume cannot be detached from a previous node to be mounted on the current node. A FailedMount event can occur when a volume cannot be mounted on the required path. Another type of event is related to the Kubernetes nodes, such as the Rebooted event (i.e., node rebooted), NodeNotReady event (i.e., node is in preparation mode and not ready to be scheduled for pods), and HostPortConflict (i.e., cluster is unreachable or is unable to connect).

The logs of the data can provide an overview of cluster performance, health of worker nodes, and performance of containers in the cluster. The information captured in the logs can be unstructured, dense, voluminous, and difficult to read without in-depth knowledge of the system.

In some embodiments, the data is received from one or more user devices 240, also known as worker machines or nodes in a container orchestration system. The data is collected and transmitted to the computer system 202 upon detection of a triggering event, such as a pod crash. In some embodiments, the data is processed by the advanced root cause analysis engine 204 upon receipt by the computer system 202. In some embodiments, the data is collected and the advanced root cause analysis engine 204 processes any data collected or received within an identified window of time or at predetermined intervals of time (e.g., daily, weekly, monthly, etc.). In some embodiments, the advanced root cause analysis engine 204 processes the data in response to a request submitted by a user of the computer system 202.

The advanced root cause analysis engine 204 receives and preprocesses the data. In some embodiments, the advanced root cause analysis engine 204 cleans, integrates, and/or transforms the data received from the user devices 240. The advanced root cause analysis engine 204 applies one or more known techniques for data cleaning, such as stemming, lemmatization, punctuation removal, Uniform Resource Locator (URL) removal, and the like, to the text of the data. The advanced root cause analysis engine 204 can integrate the different types of data (e.g., logs, pod details, events, etc.) to create a unified dataset for analysis. In some embodiments, the advanced root cause analysis engine 204 can transform the data by converting the data into a suitable format for analysis.

The advanced root cause analysis engine 204 locates errors in the preprocessed data using one or more techniques for keyword extraction. The advanced root cause analysis engine 204 provides the errors to one or more generative artificial intelligence (AI) engines, such as generative AI engine 214, which uses a reasoning template that provides the relevant causes and issues related to the error. The output is then provided to another generative AI engine 214, which uses a remediation template to determine remediation actions that correspond to the identified errors. The advanced root cause analysis engine 204 then assigns the errors to an error category and a risk level. An error category is a category of errors that is determined by a system administrator. Examples of error categories can include, but are not limited to, “security,” “reliability,” “performance and optimization,” and the like. Risk levels are labels that are indicative of a level of risk associated with the error. Examples of risk levels include “high” and “low.” The advanced root cause analysis engine 204 generates a recommendation that includes identification of the error, relevant causes and issues related to the error, remediation actions, error category, and risk level. The advanced root cause analysis engine 204 transmits the recommendation to a recommendation datastore 210.

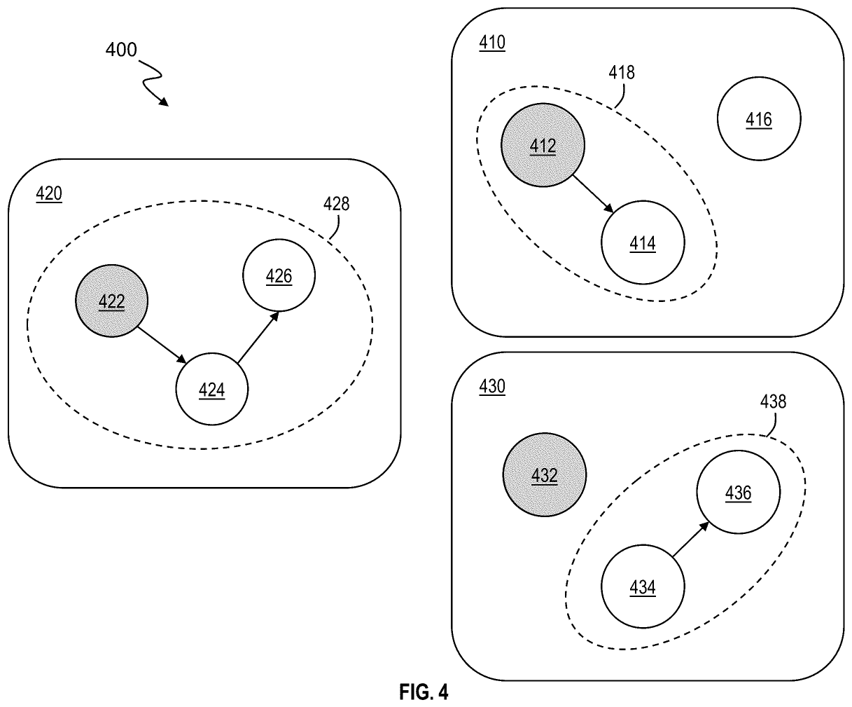

In some embodiments, the recommendation selection engine 206 receives a set of recommendations from the recommendation datastore 210. The recommendation selection engine 206 prioritizes the recommendations using scored knowledge transform graphs, which are further discussed in relation to FIG. 4. The recommendation selection engine 206 prioritizes and selects one or more recommendations that cause minimal discrepancies or minimal impact to the cluster of the container orchestration system to implement. In some embodiments, the recommendation selection engine 206 generates a discrepancy score for each recommendation, using the scored knowledge transform graph. The discrepancy score for a recommendation is generated using an absorbency score and a releasing score generated from the scored knowledge transform graph. The absorbency score is a ratio of added resources to the cluster of the container orchestration system and measures the degree to which a recommendation negatively impacts the cluster. The releasing score is a ratio of released resources of the cluster and measures the degree to which a recommendation positively impacts the cluster. The recommendation selection engine 206 selects an optimal recommendation or set of recommendations using the scored knowledge transform graph. In some embodiments, the recommendation selection engine 206 transmits the discrepancy scores for the set of recommendations to the recommendations datastore 210. The recommendation selection engine 206 transmits the discrepancy score for the selected optimal recommendation to the cluster readiness engine 208.

In some embodiments, the cluster readiness engine 208 receives the discrepancy score for an optimal recommendation or set of recommendations, such as from the recommendation selection engine 206. The cluster readiness engine 208 generates a confidence score for the cluster of the container orchestration system. The confidence score is generated using a history of recommendations that have been implemented by the cluster, a monitoring score, and the discrepancy score of the optimal recommendation generated by the recommendation selection engine 206.

In some embodiments, the cluster readiness engine 208 retrieves or otherwise obtains a history of the recommendations that have been implemented by the cluster of the container orchestration system. The history of recommendations is retrieved from the recommendations datastore 210. The monitoring score is generated by the cluster readiness engine 208 and is indicative of monitoring availability in the cluster.

The cluster readiness engine 208 generates the confidence score for the cluster of the container orchestration system and then determines a category of a readiness assessment model for the cluster using the confidence score. The readiness assessment model evaluates and measures the level of preparedness of the cluster for production readiness. Production readiness indicates that the cluster is ready to be deployed in a production environment.

In some embodiments, the readiness assessment model has multiple categories that correspond to a respective level of an ability of the cluster of the container orchestration system to implement a recommendation. The number of categories can be specified by an administrator of the system or can be a predetermined fixed value. For example, the readiness assessment model can be a REST model which has four categories, each category assigned to a range of confidence values, such as described in Table 1.

TABLE 1
Readiness Assessment Model Categories

| | Confidence | Monitoring & | | |
|---|---|---|---|---|
| Readiness | Score | Reporting of | History of | |
| Category | Range | Categories | Recommendations | Readiness Level |
| Revamp | 0-30 | <25% | <20% | Most recommendations |
| | | | | cannot be implemented |
| | | | | without a significant |
| | | | | revamp of the cluster |
| Establish | 31-50 | >25% | >20% | 25% or more of the |
| | | | | recommendations can be |
| | | | | implemented with self- |
| | | | | sufficiency |
| Sustain | 51-75 | >50% | >50% | 50% or more of the |
| | | | | recommendations can be |
| | | | | implemented with self- |
| | | | | sufficiency |
| Thrive | 76-100 | >75% | >75% | 75% or more of the |
| | | | | recommendations can be |
| | | | | implemented with self- |
| | | | | sufficiency |

A REST model is a production readiness assessment model of a cluster of a container orchestration system based on generated confidence scores. The REST model is a quantification of the preparedness level of a cluster of the container orchestration system that considers the extent of monitoring and observability in the cluster, the range and criticality of recommendations across different aspects of the cluster (e.g., security, compliance, optimization, performance, reliability, etc.), and the level of self-governance of the cluster. Assessing the preparedness level of the cluster of the container orchestration system enables users to understand the current condition or status of the cluster and identify steps to develop or advance the cluster to the next category of preparedness.

In some embodiments, the cluster readiness engine 208 generates an impact report of the optimal recommendation on the cluster of the container orchestration system. The impact report includes the optimal recommendation (e.g., error, remediation action, error category, risk level, etc.), the confidence score of the cluster, and the category of the readiness assessment model for the cluster. In some embodiments, the impact report includes additional information, such as the monitoring score and the history of recommendations implemented by the cluster. The impact report can also include suggested next steps to increase the level of preparedness for the cluster. In some embodiments, the suggested next steps are generated and provided by a generative AI engine.

In one or more embodiments, the computer system 202 may include and/or be coupled to an automated resolution system 212. Based on the remediation action in the optimal recommendation, the automated resolution system 212 is configured to modify software components, hardware components, and/or both software and hardware components of one or more user devices 240 in the computing environment, thereby resulting in improvements to the computer systems themselves. The improvements can include updates to software, software patches, increased memory, released/decreased memory, increased/decreased CPU capability, increased/decreased I/O functionality, improved cybersecurity software, etc. The modifications to the software and/or hardware components solve technical computer problems on the computer systems in the computing environment and are practical applications associated with use of the optimal recommendation. In one or more embodiments, the remediation action in the optimal recommendation is executed to address/correct the errors found on user devices 240 when the confidence score meets a threshold value such as 31 or greater, 51 or greater, 76 or greater, thereby permitting the automated resolution system 212 to perform the modifications to the software and/or hardware components. Although example values for the confidence score are illustrated, execution of the remediation action in the optimal recommendation is not limited to meeting the example threshold values for the confidence score. In one or more embodiments, the remediation action in the optimal recommendation is executed to address/correct the errors found on user devices 240 when the category of the readiness assessment model meets a threshold category such as the establish category, the sustain category, and/or the survive category, thereby permitting the automated resolution system 212 to perform the modifications to the software and/or hardware components. Although example categories for the readiness assessment model are illustrated, execution of the remediation action in the optimal recommendation is not limited to meeting the example categories for the readiness assessment model.

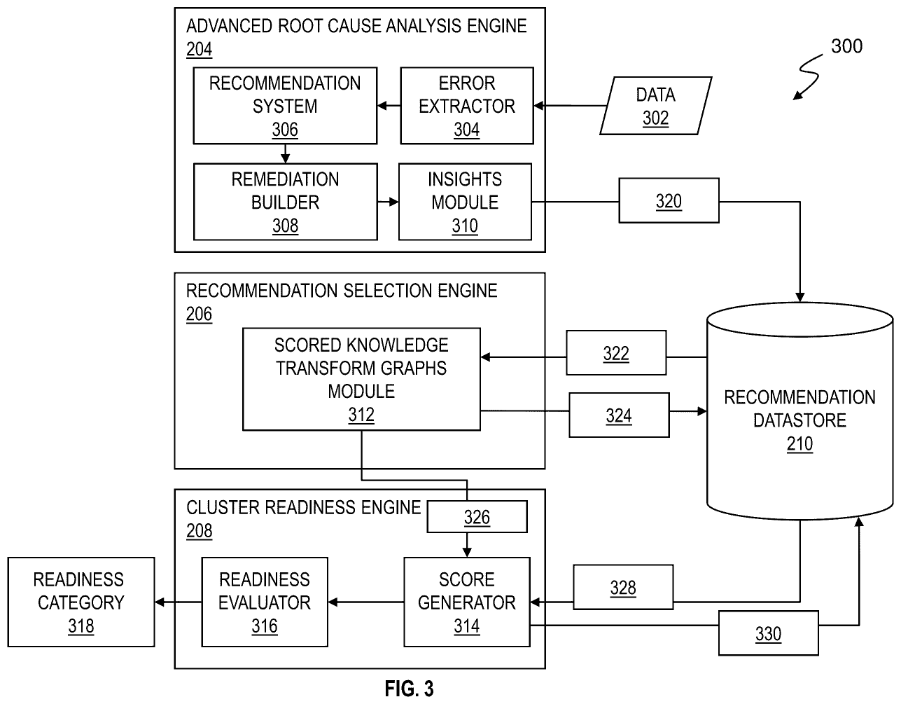

Now referring to FIG. 3, a data flow diagram 300 for prioritizing recommendations in a container orchestration system in a computing environment is depicted. The user device 240, also known as a worker machine or a node in the container orchestration system, such as the Kubernetes platform, transmits data 302 to the computer system 202. The data 302 can include pod details, logs, and/or events associated with a pod of the container orchestration system. The computer system 202 receives and stores the data 302. In some embodiments, the data 302 is stored for a predetermined time period. In some embodiments, the data 302 is stored until errors extracted from the data 302 are used to generate a recommendation.

The error extractor 304 of the advanced root cause analysis engine 204 receives and preprocesses the text of the data 302. The error extractor 304 applies one or more pre-processing techniques to the data 302, such as stemming, lemmatization, punctuation removal, URL removal, and the like. The error extractor 304 filters events of the data 302 based on the type of event and associated reasons provided in the event. The error extractor 304 locates errors in the data 302 using one or more techniques for keyword extraction. The error extractor 304 transmits the errors to the recommendation system 306 of the advanced root cause analysis engine 204.

The recommendation system 306 provides the errors from the error extractor to a generative AI engine, which uses a reasoning template that provides the potential causes and issues related to the error. The recommendation system 306 provides the output to a remediation builder 308 of the advanced root causes analysis engine 204. The remediation builder 308 provides the output from the recommendation system 306 to a generative AI engine which uses a remediation template to determine remediation actions that correspond to the identified errors. The remediation builder 308 then assigns the errors to an error category and a risk level. Examples of error categories can include “security,” “reliability,” “performance and optimization,” and the like. Examples of risk levels include “high” and “low.” The remediation builder 308 generates a recommendation that includes identification of the error, relevant causes and issues related to the error, remediation actions, error category, and risk level. In some embodiments, the insights module 310 adds insights and explanations of the different causes and issues related to the error or remediation actions for the error to the recommendation. The insights module 310 then transmits the recommendation 320 to a recommendation datastore 210.

The scored knowledge transform graphs (SKTG) module 312 of the recommendation selection engine 206 receives a set 322 of recommendations 320 from the recommendation datastore 210. The SKTG module 312 generates a discrepancy score for each recommendation 320 of the set 322 using the scored knowledge transform graph. The discrepancy score for a recommendation 320 is generated using an absorbency score and a releasing score generated from the scored knowledge transform graph. The SKTG module 312 selects an optimal recommendation or set of recommendations based on using the scored knowledge transform graph. In some embodiments, the SKTG module 312 transmits the set 324 of discrepancy scores 326 corresponding to the set 322 of recommendations 320 to the recommendations datastore 210. The SKTG module 312 transmits the discrepancy score 326 for the selected optimal recommendation 320 to the cluster readiness engine 208.

The score generator 314 of the cluster readiness engine 208 receives the discrepancy score 326 for the optimal recommendation 320 from the SKTG module 312. The score generator 314 generates a confidence score 330 for the cluster of the container orchestration system. The confidence score 330 is generated using a change score based on the history 328 of recommendations that have been implemented by the cluster of the container orchestration system, a monitoring score, and the discrepancy score 326 of the optimal recommendation.

TABLE 2
Confidence Score Calculations

| Formula | Description | Meaning |
|---|---|---|
| ${MonitoringRatio}_{category = x} = \{ \begin{matrix}0 , does not have KPI \\ 1 , has KPI\end{matrix}$ | Identifies if reporting is | Measure of monitoring for category x |
| | present for | This value is directly |
| KPI = key performance metrics | category x | proportional to the |
| | | confidence score |
| MonitoringScore = μ(MonitoringRatio_{category=x}) | Mean of the | Values indicate percentage |
| | monitoring ratio | of categories monitored, |
| | of all categories | expressed as decimal |
| | Range → 0-1 | Example: |
| | | 0.0-0% monitored |
| | | 0.5-50% monitored |
| | | 1.0-100% monitored |
| | | This value is directly |
| | | proportional to the |
| | | confidence score |
| ${δ}_{category = x} = 1 - \frac{current no . of recs - lowest no . of recs}{Range of number of recs}$ | The ratio between the change in the | 0 - maximum change in the number of recommendations in past y |
| | lowest count to | days |
| | the range of the | 1 - least change in the |
| | count of | number of |
| | recommendations | recommendations in past y |
| | for each category | days |
| | x in a specified | The readiness increases as |
| | window of time y | score moves from 0 to 1 |
| | (e.g., number of | This value is directly |
| | days) | proportional to the |
| | Range → 0-1 | confidence score |
| ChangeScore = μ(δ_{category=x}) | Mean of the δ of | |
| | all categories | |
| | Range → 0-1 | |
| $Scaled absorbency score = \{ \begin{matrix}1 , if ϑ > 1 \\ ϑ , if ϑ < 1\end{matrix}$ | The absorbency score is called to | Negative value indicates that more resources need to |
| | contain in the | be added |
| | limit of 0 to 1 | 0 - can be adjusted with |
| | | existing resources |
| | | Positive value - Resources |
| | | are optimized |
| DiscrepancyScore = | Range → 0-1 | |
| scaled (ReleasingScore − AbsorbencyScore) | | |

Confidence Score = [0.4(ChangeScore) + 0.4(MonitoringScore) + 0.2(DiscrepancyScore)] × 100

The score generator 314 generates a monitoring score that is used to generate the confidence score 330. The monitoring score measures the degree of monitoring that is present in the cluster of the container orchestration system, such as a Kubernetes cluster. The score generator 314 generates a monitoring ratio for each error category, represented as x. The monitoring ratio indicates the presence of a monitoring tool that measures key performance metrics of the cluster of the container orchestration system for the different error categories, such as security, compliance, optimization, performance, reliability, etc. In some embodiments, the score generator 314 identifies the monitoring tool. In some embodiments, the score generator 314 determines if data (e.g., logs, events, etc.) for a specific key performance metric is being received to determine the presence of the monitoring tool. The formula for determining the monitoring ratio is depicted below.

$$M o n i t o r ingRati {o}_{category = x} = \{ \begin{matrix}0 , does not have KPI \\ 1 , has KPI\end{matrix}$$

To determine the monitoring score, the score generator takes the mean of all the monitoring ratios for all the error categories, as depicted in the formula below. The range of the values for the monitoring score is between 0 and 1, where the value represents the percentage of error categories monitored, expressed as a decimal.

$$MonitoringScore = μ ( {MonitoringRatio}_{category = x} )$$

In some embodiments, the score generator 314 uses the history 328 of the recommendations that have been implemented by the cluster of the container orchestration system from the recommendations datastore 210 to generate a change score. In some embodiments, the period of time for the history 328 is a predetermined number of days. The predetermined number of days can be determined by an administrator of the system. The score generator 314 retrieves or otherwise obtains the history 328 of the recommendations from the recommendations datastore 210 for the predetermined number of days. The score generator generates a delta score for each error category, where the delta score for each category is represented as δ_{category=x} and x is the error category. The δ_{category=x} is calculated by finding the ratio between the change in the lowest number of recommendations implemented to the range of the number of recommendations, as depicted in the formula below.

$${δ}_{category = x} = 1 - \frac{current no . of recs - lowest no . of recs}{Range of number of recs}$$

To determine the change score, the score generator takes the mean of all the delta scores for all the error categories, as depicted in the formula below. The range of the values for the change score is between 0 and 1, where 0 indicates that the maximum number of changes in the number of recommendations implemented by the container orchestration system and 1 indicates that the least number of changes in the number of recommendations implemented by the container orchestration system in the predetermined window of time.

$$ChangeScore = μ ( {δ}_{category = x} )$$

The score generator 314 generates the confidence score using the monitoring score, the change score, and the discrepancy score 326 received from the SKTG module 312. One example formula for generating the confidence score is depicted below.

$$Confidence Score = [ 0.4 ( ChangeScore ) + 0.4 ( MonitoringScore ) + 0.2 ( DiscrepancyScore ) ] \times 100$$

The score generator 314 transmits the confidence score 330 to the recommendation datastore 210 and to the readiness evaluator 316.

The readiness evaluator 316 of the cluster readiness engine 208 uses the confidence score 330 for the cluster of the container orchestration system and then determines or selects a readiness category 318 of a readiness assessment model for the cluster using the confidence score 330. For example, the readiness evaluator 316 can use the REST model as the readiness assessment model, such as described in Table 1. The REST model has four readiness categories 318, each readiness category 318 assigned to a range of confidence values. The readiness evaluator 316 selects the readiness category 318 of the REST model that corresponds to the confidence score 330.

FIG. 4 is a block diagram 400 depicting example scored knowledge transformation graphs recommendation prioritization for a container orchestration system. In some embodiments, the SKTG module 312 uses scored knowledge transform graphs to generate discrepancy scores for recommendations 320. A discrepancy score measures the adjustments needed in the container orchestration system, such as the Kubernetes platform, to implement a recommendation 320.

The SKTG module 312 has an initial collection of foreknowledge in a super graph (K) that includes nodes (V), a scored final transformed knowledge collection (T), and a set of disconnected directed knowledge graphs (kₙ) of the attributes or resources of the cluster of the container orchestration system (e.g., memory, CPU, etc.). Each node represents a recommendation 320 and is associated with three parameters—attribute (A), impact (I), and risk (R). The attribute is the resource of the cluster of the container orchestration system affected by the recommendation 320. The impact is a value that indicates how the recommendation 320 affects the resource. If the node has a negative impact value, then it is a releasing node which indicates that the node will release resources. If the node has a positive impact value, then it is an absorbing node and indicates that the node needs additional resources. The risk value is the value assigned to the recommendation 320 by the directed edges (Eₘₖₙ) from node Vₙₖₙ to node V₍ₙ₊₁₎ₖₙ in disconnected knowledge graph kₙ are determined by a transformation completion rule set (R) so that when K is transferred across kₙ, the knowledge in K is transformed at each node that holds the existing knowledge of the subject using the edge function f(x=attribute) at Eₘₖₙ and the initial predefined criteria is met. The predefined criteria are a set of conditions created by a subject matter expert. An example of the edge function is shown below:

$$f ( x = attribute , {V}_{nkn} ) = \{ \begin{matrix}f ( {V}_{( n - 1 ) kn} - {I}_{nkn} , & n > 1 \\ K ( x = attribute ) , & n = 1\end{matrix}$$

An example of a transformation completion rule set R includes (1) the initial node must be a releasing with the lowest impact (I) available; (2) the absorbency rate of the node Vₙₖₙ should be less than the node V_{(n-1) kn}; and (3) skip the nodes that transforms beyond the predefined criteria determined by a subject matter expert.

The SKTG module 312 determines an absorbency score, a releasing score, and a priority inclusion score for each recommendation 320. The absorbency score measures the degree to which a recommendation 320 negatively impacts the cluster of the container orchestration system, such as a Kubernetes cluster, by absorbing or requiring additional resources. The releasing score measures the degree to which a recommendation positively impacts the cluster of the container orchestration system by releasing resources. The precision inclusion score indicates how many high priority recommendations are able to be implemented without causing any issues to the cluster of the container orchestration system. Example formulas for the absorbency score, releasing score, and priority inclusion score are shown below:

$$Absorbency Score = {\sum }_{k = 1}^{n} ϑ where ϑ = \frac{\sum {I}_{HA} + \sum {I}_{LA}}{K ( xn )}$$

$$Releasing Score = {\sum }_{k = 1}^{n} φ where φ = \frac{\sum {I}_{HR} + \sum {I}_{LR}}{K ( xn )}$$

The I_{xy} is the impact value where x is the risk level assigned by the remediation builder 308 (e.g., High (H) or Low (L)) and y is the node type (Absorbing (A) or Releasing (R)).

$$Priority Inclusion = \frac{Total Nodes with risk = H in Kn}{Total Nodes with Risk = H for x}$$

FIG. 4 depicts example scored knowledge transformation graphs for recommendation prioritization for a container orchestration system. For the examples, K={Mem=3072 MB}; the predetermined criteria is T(x)<=K(x); and n=1. For the example 410, the directed knowledge graph 418 includes node 412 and 414. Node 412 has an attribute parameter that indicates the resource is memory, the impact value is −872, and the risk level is low. The negative impact value indicates that node 412 is a releasing node. Node 414 has an attribute parameter that indicates the resource is memory, the impact value is +300, and the risk level is high. The positive impact value indicates that node 414 is an absorbing node. Node 416, which is not included in the directed knowledge graph 418, has an attribute parameter that indicates the resource is memory, the impact value is +500, and the risk level is high. Based on the parameters of nodes in the directed knowledge graph 418, the SKTG module 312 determines that T={mem=2500 MB}, the absorbency score is 0.09, the releasing score is 0.28, and the priority inclusion score is 0.5.

For the example 420, the directed knowledge graph 428 includes node 422, 424, and 426. Node 422 has an attribute parameter that indicates the resource is memory, the impact value is −872, and the risk level is low. The negative impact value indicates that node 422 is a releasing node. Node 424 has an attribute parameter that indicates the resource is memory, the impact value is +300, and the risk level is high. Node 426 has an attribute parameter that indicates the resource is memory, the impact value is +500, and the risk level is high. The positive impact values of nodes 424 and 426 indicate that the nodes are absorbing nodes. Based on the parameters of nodes in the directed knowledge graph 428, the SKTG module 312 determines that T={mem=3000 MB}, the absorbency score is 0.26, the releasing score is 0.28, and the priority inclusion score is 1.0.

For the example 430, the directed knowledge graph 438 includes node 434 and 436. Node 432, which is not included in the directed knowledge graph 438, has an attribute parameter that indicates the resource is memory, the impact value is −872, and the risk level is low. Node 434 has an attribute parameter that indicates the resource is memory, the impact value is +300, and the risk level is high. Node 436 has an attribute parameter that indicates the resource is memory, the impact value is +500, and the risk level is high. The positive impact values of nodes 434 and 436 indicate that the nodes are absorbing nodes. Based on the parameters of nodes in the directed knowledge graph 428, the SKTG module 312 determines that T={mem=3944 MB}, the absorbency score is 0.26, the releasing score is 0.0, and the priority inclusion score is 0.5.

Based on the calculated scores for each example, the SKTG module 312 determines that example 420 is the optimal recommendation 320 based on the higher priority inclusion score than examples 410 and 430. The SKTG module 312 generates discrepancy scores for each example using the calculated scores and transmits the set of discrepancy scores to the recommendation datastore 210 and the discrepancy score for the optimal recommendation (e.g., example 420) to the cluster readiness engine 208.

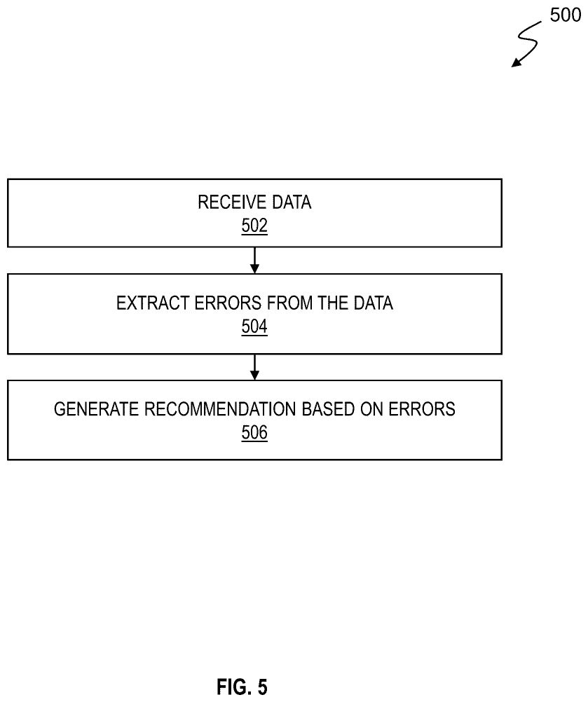

Now referring to FIG. 5, a flowchart depicts a computer-implemented method 500 for generating a recommendation in a container orchestration system in a computing environment. The computer-implemented method 500 is executed by the computer system 202. Reference can be made to any figures discussed herein.

At block 502 of the computer-implemented method 500, the error extractor 304 of the advanced root cause analysis engine 204 receives and preprocesses the data 302. The data 302 can include pod details, events, and logs associated with a pod of a container orchestration system, such as a Kubernetes pod. Pod details can include data indicating the status of the pod. Pod details can include the state of each container in the pod.

Next at block 504, the error extractor 304 applies one or more pre-processing techniques to the data 302. Examples of pre-processing techniques include stemming, lemmatization, punctuation removal, URL removal, and the like. The error extractor 304 utilizes one or more known techniques for keyword extraction to locate errors in the data 302. The error extractor 304 transmits the errors to the recommendation system 306 of the advanced root cause analysis engine 204.

Next at block 506, the recommendation system 306 provides the identified errors to a generative AI engine. In some embodiments, the generative AI engine uses a reasoning template that provides the potential causes and issues related to the error. The recommendation system 306 transmits the potential causes and issues related to the error to a remediation builder 308 of the advanced root causes analysis engine 204, which then submits the potential causes and issues to another generative AI engine. The generative AI engine uses a remediation template to determine remediation actions that correspond to the identified errors. The remediation builder 308 then assigns the errors to an error category and a risk level.

Next at block 506, the remediation builder 308 generates a recommendation 320. In some embodiments, the recommendation 320 includes the error, relevant causes and issues related to the error, remediation actions, error category, and risk level. In some embodiments, the recommendation 320 also includes insights and explanations of the different causes and issues related to the error or remediation actions for the error. The insights module 310 then transmits the recommendation 320 to a recommendation datastore 210.

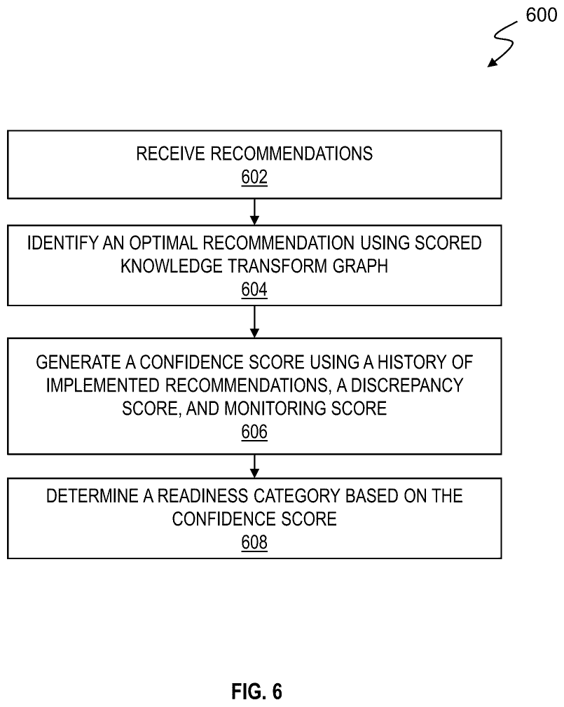

Now referring to FIG. 6, a flowchart depicts a computer-implemented method 600 for assessing the readiness of container clusters in a container orchestration system in a computing environment. The computer-implemented method 600 is executed by the computer system 202. Reference can be made to any figures discussed herein.

At block 602 the computer-implemented method 600, the SKTG module 312 of the recommendation selection engine 206 receives a set 322 of recommendations 320. The set 322 of recommendations 320 is obtained or otherwise retrieved from the recommendation datastore 210. At block 604, the SKTG module identifies an optimal recommendation 320 using a scored knowledge transform graph. In some embodiments, the SKTG module 312 generates a discrepancy score for each recommendation from the set 322 of recommendations. For each recommendation 320, the SKTG module 312 uses the scored knowledge transform graph to determine an absorbency score and a releasing score and then generates a discrepancy score using the absorbency score and the releasing score. The SKTG module 312 selects an optimal recommendation or set of optimal recommendations using the scored knowledge transform graph. In some embodiments, the SKTG module 312 transmits the set 324 of discrepancy scores 326 corresponding to the set 322 of recommendations 320 to the recommendations datastore 210. The SKTG module 312 transmits the discrepancy score 326 for the selected optimal recommendation 320 to the cluster readiness engine 208.

Next at block 606, the score generator 314 of the cluster readiness engine 208 generates a confidence score using the history 328 of recommendations that have been implemented by the cluster of the container orchestration system, a monitoring score, and the discrepancy score 326 received from the SKTG module 312. The score generator 314 generates a confidence score 330 for the cluster of the container orchestration system, such as the Kubernetes cluster. The confidence score 330 is generated using a change score based on the history 328 of recommendations that have been implemented by the cluster of the container orchestration system, a monitoring score, and the discrepancy score 326 of the optimal recommendation.

In some embodiments, the score generator 314 generates the change score using the history 328 of the recommendations that have been implemented by the cluster of the container orchestration system. The score generator generates a delta score for each error category by finding the ratio between the change in the lowest number of recommendations implemented to the range of the number of recommendations. The score generator takes the mean of all the delta scores for all the error categories to generate the change score.

The score generator 314 generates a monitoring ratio for each error category, which indicates the presence of a monitoring tool that measures key performance metrics of the cluster of the container orchestration system for the different error categories. In some embodiments, the score generator 314 determines if data for a specific key performance metric is being received to determine the presence of the monitoring tool. The score generator 314 generates the confidence score using the monitoring score, the change score, and the discrepancy score 326 received from the SKTG module 312.

Next at block 608, the readiness evaluator 316 of the cluster readiness engine 208 uses the confidence score 330 to determine a readiness category 318 of a readiness assessment model for the cluster of the container orchestration system using the confidence score 330. For example, the readiness evaluator 316 can use a readiness assessment model, such as the REST model, which is associated with multiple readiness categories 318, each one assigned to a range of confidence values. The readiness evaluator 316 selects the readiness category 318 of the readiness assessment model that corresponds to the confidence score 330.

In some embodiments, the cluster readiness engine 208 generates an impact report that includes the optimal recommendation 320, the confidence score of the cluster of the container orchestration system, and the readiness category of the readiness assessment model for the cluster. The impact report can also include the monitoring score and the history of recommendations implemented by the cluster of the container orchestration system and suggested next steps to increase the level of preparedness for the cluster of the container orchestration system.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described herein above, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

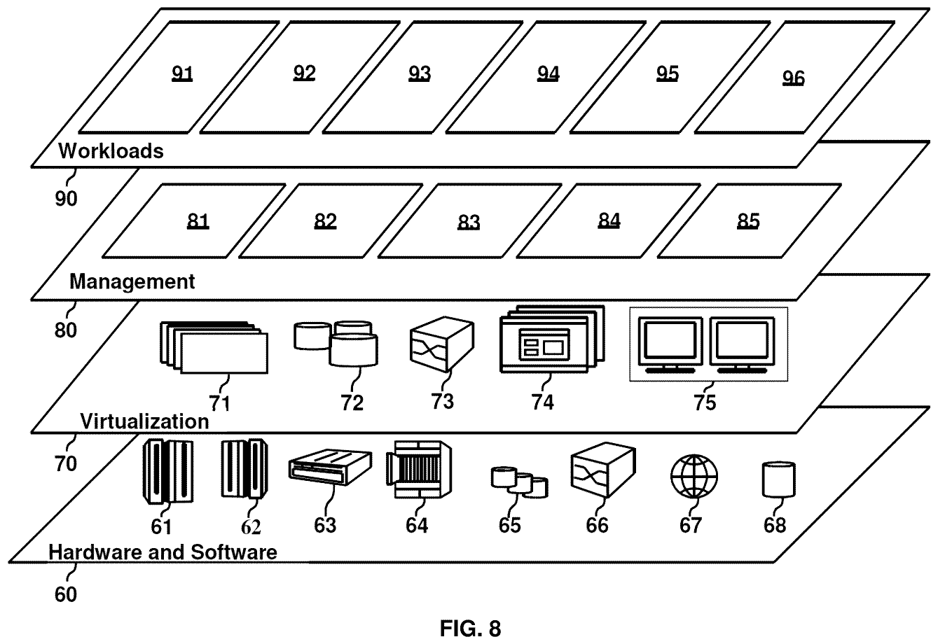

Referring now to FIG. 8, a set of functional abstraction layers provided by cloud computing environment 50 (depicted in FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and workloads and functions 96. Examples of workloads and functions 96 includes recommendation prioritization for a container orchestration system that uses scored knowledge transforming graphs to determine the impact of a recommendation on a container orchestration system and selects an optimal recommendation based on the recommendation impact. In another example, workloads and functions 96 includes a system that quantifies the production readiness of a cluster of a container orchestration system using a readiness assessment model to enable users to increase effective capacity planning, performance monitoring, and resource optimization of a cluster of a container orchestration system.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for the purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving a set of recommendations for a cluster of a container orchestration system;
selecting an optimal recommendation from the set of recommendations using a scored knowledge transform graph;
generating a confidence score for the cluster based on the optimal recommendation;
determining a category of a readiness assessment model for the cluster using the confidence score; and
modifying a computer resource of the cluster based on the category of the readiness assessment model.

2. The computer-implemented method of claim 1, further comprising:
receiving data comprising logs, events, and details of a pod of the container orchestration system in the cluster;
identifying an error from the data;
determining a remediation action for the error; and
generating a recommendation for the set of recommendations, wherein the recommendation for the set of recommendations comprises the error, the remediation action, an error category for the error, and a risk level for the error.

3. The computer-implemented method of claim 1, wherein generating the confidence score for the cluster based on the optimal recommendation further comprises using a history of recommendations for the cluster, a discrepancy score of the optimal recommendation, and a monitoring score indicative of monitoring availability in the cluster.

4. The computer-implemented method of claim 1, wherein selecting the optimal recommendation from the set of recommendations using the scored knowledge transform graph further comprises:
generating a discrepancy score for each recommendation of the set of recommendations; and
selecting the optimal recommendation from the set of recommendations using the discrepancy score for each recommendation of the set of recommendations.

5. The computer-implemented method of claim 4, wherein the discrepancy score for each recommendation of the set of recommendations is generated using a ratio of added resources and a ratio of released resources of the cluster based on each recommendation of the set of recommendations.

6. The computer-implemented method of claim 1, wherein the readiness assessment model comprises four categories and each of the four categories corresponds to a respective level of an ability of the cluster to implement the optimal recommendation.

7. The computer-implemented method of claim 1, further comprising:
generating an impact report of the optimal recommendation on the cluster comprising the optimal recommendation, the confidence score of the cluster, and the category of the readiness assessment model for the cluster.

8. A system comprising:
a memory having computer readable instructions; and
one or more processors for executing the computer readable instructions, the computer readable instructions controlling the one or more processors to perform operations comprising:
receiving a set of recommendations for a cluster of a container orchestration system;
selecting an optimal recommendation from the set of recommendations using a scored knowledge transform graph;
generating a confidence score for the cluster based on the optimal recommendation;
determining a category of a readiness assessment model for the cluster using the confidence score; and
modifying a computer resource of the cluster based on the category of the readiness assessment model.

9. The system of claim 8, wherein the operations further comprise:
receiving data comprising logs, events, and details of a pod of the container orchestration system in the cluster;
identifying an error from the data;
determining a remediation action for the error; and
generating a recommendation for the set of recommendations, wherein the recommendation for the set of recommendations comprises the error, the remediation action, an error category for the error, and a risk level for the error.

10. The system of claim 8, wherein the operations to generate the confidence score for the cluster based on the optimal recommendation further comprise using a history of recommendations for the cluster, a discrepancy score of the optimal recommendation, and a monitoring score indicative of monitoring availability in the cluster.

11. The system of claim 8, wherein the operations to select the optimal recommendation from the set of recommendations using the scored knowledge transform graph further comprise:
generating a discrepancy score for each recommendation of the set of recommendations; and
selecting the optimal recommendation from the set of recommendations using the discrepancy score for each recommendation of the set of recommendations.

12. The system of claim 11, wherein the discrepancy score for each recommendation of the set of recommendations is generated using a ratio of added resources and a ratio of released resources of the cluster based on each recommendation of the set of recommendations.

13. The system of claim 8, wherein the readiness assessment model comprises four categories and each of the four categories corresponds to a respective level of an ability of the cluster to implement the optimal recommendation.

14. The system of claim 8, wherein the operations further comprise:
generating an impact report of the optimal recommendation on the cluster comprising the optimal recommendation, the confidence score of the cluster, and the category of the readiness assessment model for the cluster.

15. A computer program product comprising a computer readable storage medium having program instructions embodied therewith, the program instructions executable by one or more processors to cause the one or more processors to perform operations comprising:
receiving a set of recommendations for a cluster of a container orchestration system;
selecting an optimal recommendation from the set of recommendations using a scored knowledge transform graph;
generating a confidence score for the cluster based on the optimal recommendation;
determining a category of a readiness assessment model for the cluster using the confidence score; and
modifying a computer resource of the cluster based on the category of the readiness assessment model.

16. The computer program product of claim 15, wherein the operations further comprise:
receiving data comprising logs, events, and details of a pod of the container orchestration system in the cluster;
identifying an error from the data;
determining a remediation action for the error; and
generating a recommendation for the set of recommendations, wherein the recommendation for the set of recommendations comprises the error, the remediation action, an error category for the error, and a risk level for the error.

17. The computer program product of claim 15, wherein the operations to generate the confidence score for the cluster based on the optimal recommendation further comprise using a history of recommendations for the cluster, a discrepancy score of the optimal recommendation, and a monitoring score indicative of monitoring availability in the cluster.

18. The computer program product of claim 15, wherein the operations to select the optimal recommendation from the set of recommendations using the scored knowledge transform graph further comprise:
generating a discrepancy score for each recommendation of the set of recommendations; and
selecting the optimal recommendation from the set of recommendations using the discrepancy score for each recommendation of the set of recommendations.

19. The computer program product of claim 18, wherein the discrepancy score for each recommendation of the set of recommendations is generated using a ratio of added resources and a ratio of released resources of the cluster based on each recommendation of the set of recommendations.

20. The computer program product of claim 15, wherein the readiness assessment model comprises four categories and each of the four categories corresponds to a respective level of an ability of the cluster to implement the optimal recommendation.
